(19) United States
(12) Patent Application Publication
(10) Pub. No.: US 2025/0282159 A1
(43) Pub. Date: Sep. 11, 2025

(54) SKEW CORRECTION DEVICE, MEDIUM PROCESSING APPARATUS AND CONTROL METHOD FOR SKEW CORRECTION DEVICE

(71) Applicant: SEIKO EPSON CORPORATION, Tokyo (JP)

(72) Inventors: Hiroyuki MAEDA, MATSUMOTO-SHI (JP); Koki MURAKAMI, AGEMATSU-MACHI (JP)

(21) Appl. No.: 19/071,869

(22) Filed: Mar. 6, 2025

(30) Foreign Application Priority Data
Mar. 8, 2024 (JP) 2024-036092

(51) Int. Cl. B41J 13/32

(52) U.S. Cl. CPC B41J 13/32

(57) ABSTRACT

An skew correction device includes a registration roller pair, a driving unit that drives the registration roller pair, an electromagnetic clutch that stops the registration roller pair in an activated state and releases the registration roller in a disconnected state, and the driving unit drives the registration roller pair with a first output when the registration roller pair transports the medium, and performs driving with a second output smaller than the first output in the activated state. As a result, skew correction of the medium is performed in a state in which a backlash is eliminated.

The present application is based on, and claims priority from JP Application Serial Number 2024-036092, filed Mar. 8, 2024, the disclosure of which is hereby incorporated by reference herein in its entirety.

### BACKGROUND

### 1. Technical Field

The present disclosure relates to an skew correction device, a medium processing apparatus, and a control method for an skew correction device.

### 2. Related Art

As an example of this type of apparatus, an apparatus disclosed in JP 2004-26375 A can be exemplified. JP 2004-26375 A describes that skew can be eliminated even from a thick sheet by fixing a registration roller and stopping rotation thereof by an electromagnetic clutch. A structure is adopted in which, when a leading end of the sheet is caused to butt at the registration roller to eliminate the skew, driving force is not transmitted to the registration roller.

There is a case where a gap is generated at a coupling portion between the electromagnetic clutch and a shaft, an inside of the electromagnetic clutch, or the like. Hereinafter, this gap is also referred to as “backlash”. In this case, even when the electromagnetic clutch is activated, the registration roller can rotate by an amount corresponding to the backlash. That is, reaction force of the sheet causes the leading end of the sheet to pass through a nip position of the registration roller by the amount corresponding to the backlash, and thus there is a risk that skew correction, that is, skew correction becomes insufficient.

### SUMMARY

In order to solve the above-described problems, an skew correction device according to the present disclosure is an skew correction device that corrects skew by placing a leading end of a medium at a nip position of a registration roller pair, the skew correction device including the registration roller pair, a driving unit configured to drive the registration roller pair, and an electromagnetic clutch configured to stop the registration roller pair in an activated state and release the registration roller pair in a disconnected state, wherein the driving unit drives the registration roller pair with a first output when the registration roller pair transports the medium, and performs driving with a second output smaller than the first output in the activated state.

Additionally, a medium processing apparatus according to the present disclosure includes an skew correction device according to any one aspect of a first aspect to a fifth aspect described below, an upstream transport unit configured to transport the medium to the skew correction device, a downstream transport unit configured to transport the medium whose skew has been corrected by the skew correction device, and a processing unit configured to perform processing on the medium transported through the downstream transport unit.

Additionally, a control method for an skew correction device according to the present disclosure is a control method for an skew correction device that corrects skew by placing a leading end of a medium at a nip position of a registration roller pair, the control method including, when the medium is transported by the registration roller pair, releasing the registration roller pair, by setting an output of a driving unit that drives the registration roller pair to a first output bringing an electromagnetic clutch into a disconnected state, and, when the registration roller pair is stopped, stopping the registration roller pair, by setting the output of the driving unit to a second output smaller than the first output and bringing the electromagnetic clutch into an activated state.

### BRIEF DESCRIPTION OF THE DRAWINGS

FIG. 1 is a diagram for explaining a transport path of a medium processing apparatus according to Embodiment 1.

FIG. 2 is a schematic plan view of a part of an skew correction device and a driving unit according to Embodiment 1.

FIG. 3 is a schematic diagram for explaining operation of a registration roller pair according to Embodiment 1.

FIG. 4 is a schematic diagram for explaining the operation of the registration roller pair according to Embodiment 1.

FIG. 5 is a schematic diagram for explaining the operation of the registration roller pair according to Embodiment 1 and Embodiment 2.

FIG. 6 is a schematic diagram for explaining the operation of the registration roller pair according to Embodiment 1.

FIG. 7 is a flowchart for explaining skew correction by the skew correction device according to Embodiment 1.

FIG. 8 is a flowchart for explaining skew correction by

an skew correction device according to Embodiment 2.

FIG. 9 is a perspective view of a main part of a registration roller pair according to Embodiment 3.

### DESCRIPTION OF EMBODIMENTS

First, the present disclosure is schematically described below.

In order to solve the above-described problems, an skew correction device according to a first aspect of the present disclosure is an skew correction device that corrects skew by placing a leading end of a medium at a nip position of a registration roller pair, the skew correction device including the registration roller pair, a driving unit configured to drive the registration roller pair, and an electromagnetic clutch configured to stop the registration roller pair in an activated state and release the registration roller pair in a disconnected state, wherein the driving unit drives the registration roller pair with a first output when the registration roller pair transports the medium, and performs driving with a second output smaller than the first output in the activated state.

Here, in “correcting skew by causing the leading end of the medium to butt at”, “correcting skew” includes reducing the skew of the medium, and is used in a meaning that it is not necessary to strictly eliminate the skew of the medium.

According to the aspect, while the electromagnetic clutch is in the disconnected state, when the registration roller pair transports the medium, the driving unit drives the registration roller pair with the first output. Even when the electromagnetic clutch is brought into the activated state and the registration roller pair is brought into a stopped state, the driving unit does not stop driving and drives the registration roller pair with the second output.

Accordingly, even when there is the backlash in a power transmission path from the driving unit to the registration roller pair, the backlash can be brought into an eliminated state. Therefore, when the leading end of the medium is caused to butt at the nip position of the registration roller pair for the skew correction, the registration roller pair is prevented from being rotated by reaction force of the medium. That is, the leading end of the medium is prevented from passing through the nip position. This makes it possible to improve accuracy of the skew of the medium.

In addition, the second output which is driving force of the driving unit when the backlash is eliminated is set to be smaller than the first output which is driving force when the medium is transported. Accordingly, an increase in power consumption in the driving unit can be suppressed. In addition, since the second output is smaller than the first output, it is possible to suppress an increase in holding force required for the electromagnetic clutch, which leads to cost reduction.

In addition, according to the aspect, it is possible to suppress an increase in a load of the driving unit such as a motor, as compared to a configuration in which rotation of the registration roller pair due to reaction force of the medium is suppressed by increasing a sliding load during rotation of the registration roller pair. Accordingly, it is possible to suppress an increase in power consumption in the driving unit, and additionally, it is possible to reduce a size of the driving unit.

The skew correction device according to a second aspect of the present disclosure is an aspect dependent on the first aspect, further including a control unit configured to control the driving unit and the electromagnetic clutch, wherein the control unit sets an output of the driving unit to the second output and brings the electromagnetic clutch into the activated state when the registration roller pair is stopped, and sets the output of the driving unit to the first output and brings the electromagnetic clutch into the disconnected state when the medium is transported by the registration roller pair.

According to the aspect, when the registration roller pair is stopped, the control unit performs control so as to set the output of the driving unit to the second output and bring the electromagnetic clutch into the activated state. When the medium is transported by the registration roller pair, the control unit performs control so as to set the output of the driving unit to the first output and bring the electromagnetic clutch into the disconnected state. Accordingly, it is possible to easily obtain effects of the first aspect by the control unit performing the control.

The skew correction device according to a third aspect of the present disclosure is an aspect dependent on the second aspect, further including a detection unit configured to detect information related to the medium, wherein the control unit determines whether to drive the driving unit or not when the registration roller pair is stopped based on a detection result of the detection unit.

Here, the “information related to the medium” means physical information related to rigidity such as a thickness, a basis weight, or the like of the medium, but may be a parameter related to the physical information.

When the medium is caused to butt at the nip position of the registration roller pair, as an example, a case of a medium in which rigidity thereof is low and the reaction force is small may lead to a state in which sliding resistance of the registration roller pair or the like is larger. In this state, the reaction force is less likely to rotate the registration roller pair, thus it is possible to perform the skew correction with high accuracy without eliminating the backlash.

According to the aspect, the control unit determines whether to drive the driving unit or not when the registration roller pair is stopped, based on a detection result of the detection unit that detects information related to the medium. This makes it possible to stop the driving unit when the registration roller pair is less likely to rotate for the medium having the small reaction force or the like, and to drive the driving unit when the registration roller pair is easy to rotate for the medium having the large reaction force or the like, thus it is possible to avoid unnecessary driving of the driving unit and to suppress power consumption.

The skew correction device according to a fourth aspect of the present disclosure is an aspect dependent on the third aspect, wherein the information related to the medium includes information related to a thickness of the medium, and when the thickness of the medium is a first thickness, the control unit drives the driving unit with the second output when the registration roller pair is stopped, and when the thickness of the medium is a second thickness smaller than the first thickness, the control unit does not drive the driving unit when the registration roller pair is stopped.

When the thickness of the medium is larger, the reaction force when the medium is caused to butt at the nip position of the registration roller pair is larger, and the leading end of the medium easily passes through the nip position. On the other hand, when the thickness of the medium is smaller, the reaction force when the medium is caused to butt at the nip position of the registration roller pair is smaller, and the leading end of the medium is hard to pass through the nip position.

According to the aspect, when the thickness of the medium is the first thickness, the control unit performs control so as to drive the driving unit with the second output when the registration roller pair is stopped. On the other hand, when the thickness of the medium is the second thickness smaller than the first thickness, the control unit performs control so as not to drive the driving unit when the registration roller pair is stopped. That is, when the thickness of the medium is large, the backlash is eliminated by the driving unit, and when the thickness of the medium is small, the backlash is not eliminated. Accordingly, it is possible to suppress unnecessary driving of the driving unit, thereby suppressing an increase in power consumption.

The skew correction device according to a fifth aspect of the present disclosure is an aspect dependent on the first aspect, wherein the registration roller pair includes a toothed roller.

Here, the “toothed roller” refers to a roller having a plurality of protrusions at an outer surface thereof, and means a roller in which portions of the protrusions come into contact with the medium so that contact areas with the medium can be brought into a point contact state.

Note that the aspect may also depend on any one aspect of the second aspect to the fourth aspect.

When the registration roller pair includes the toothed roller, there is a problem in that the registration roller pair is structurally more likely to rotate when the registration roller pair is subjected to the butting of the medium as compared with a registration roller without the projections.

According to the aspect, since the backlash is in the eliminated state, the registration roller pair can effectively perform skew correction without being affected by the problem caused by movement of the registration roller pair due to the backlash.

In particular, in a configuration in which skew of the medium is corrected again by the registration roller pair for double-sided printing, transfer can be suppressed by using the toothed roller.

A medium processing apparatus according to a sixth aspect includes the skew correction device according to any one aspect of the first aspect to the fifth aspect, an upstream transport unit configured to transport the medium to the skew correction device, a downstream transport unit configured to transport the medium whose skew has been corrected by the skew correction device, and a processing unit configured to perform processing on the medium transported through the downstream transport unit.

According to the aspect, in the medium processing apparatus including the processing unit that performs processing on the medium being transported, it is possible to appropriately perform skew correction of the medium, and it is possible to improve accuracy of the processing.

The medium processing apparatus according to a seventh aspect of the present disclosure is an aspect dependent on the sixth aspect, wherein the upstream transport unit is driven by a second driving unit that is different from the driving unit.

According to the aspect, the upstream transport unit is driven by the second driving unit different from the driving unit. Accordingly, since the driving unit of the registration roller pair is provided separately from the second driving unit of the upstream transport unit, it is possible to suppress influence of the control of driving by the driving unit with weak driving force, that is, the second output on the driving force when the medium is caused to butt at the nip position by the second driving unit. Consequently, it is possible to suppress an increase in a time of the butting and to suppress a decrease in throughput.

The medium processing apparatus according to an eighth aspect of the present disclosure is an aspect dependent on the sixth aspect, wherein the downstream transport unit is driven by a third driving unit that is different from the driving unit.

Note that the aspect may also depend on the seventh aspect.

According to the aspect, the downstream transport unit is driven by the third driving unit different from the driving unit. Accordingly, since the driving unit of the registration roller pair is provided separately from the third driving unit of the downstream transport unit, it is possible to suppress influence of the control of driving by the driving unit with the weak driving force, that is, the second output, on transport force for transporting a preceding medium downstream by the third driving unit. Consequently, it is possible to suppress an increase in a processing time of the preceding medium by the processing unit and to suppress a decrease in throughput.

The medium processing apparatus according to a ninth aspect of the present disclosure is an aspect dependent on the sixth aspect, wherein the driving unit drives only the registration roller pair.

Note that the aspect can also be dependent on the seventh aspect or the eighth aspect.

According to the aspect, the driving unit drives only the registration roller pair. Accordingly, since the driving unit is a dedicated driving unit for the registration roller pair, it is possible to set magnitude of driving force without affecting a driving state of other units. That is, magnitude of the second output can be set to be small without affecting the driving state of the other units.

The medium processing apparatus according to a tenth aspect of the present disclosure is an aspect dependent on the sixth aspect, wherein the processing unit is a recording unit that performs recording on a medium, and recording is performed in the recording unit on the medium whose skew has been corrected in the skew correction device.

Note that the aspect may also depend on any one aspect of the seventh aspect to the ninth aspect.

According to the aspect, since it is possible to appropriately perform the skew correction before the medium on which recording is to be performed is transported to a recording performance region by the recording unit, it is possible to improve recording accuracy.

A control method for an skew correction device according to an eleventh aspect of the present disclosure is a control method for an skew correction device that corrects skew by placing a leading end of a medium at a nip position of a registration roller pair, the control method including, releasing the registration roller pair, when the medium is transported by the registration roller pair, by setting an output of a driving unit that drives the registration roller pair to a first output and bringing an electromagnetic clutch into a disconnected state, and stopping the registration roller pair, when the registration roller pair is stopped, by setting the output of the driving unit to a second output smaller than the first output and bringing the electromagnetic clutch into an activated state.

According to the aspect, the same effect as in the first aspect can be obtained.

The control method for the skew correction device according to a twelfth aspect includes acquiring information related to the medium, and determining whether to drive the driving unit or not when the registration roller pair is stopped based on the information related to the medium acquired.

According to the aspect, the same effect as in the fourth aspect can be obtained.

### EMBODIMENTS

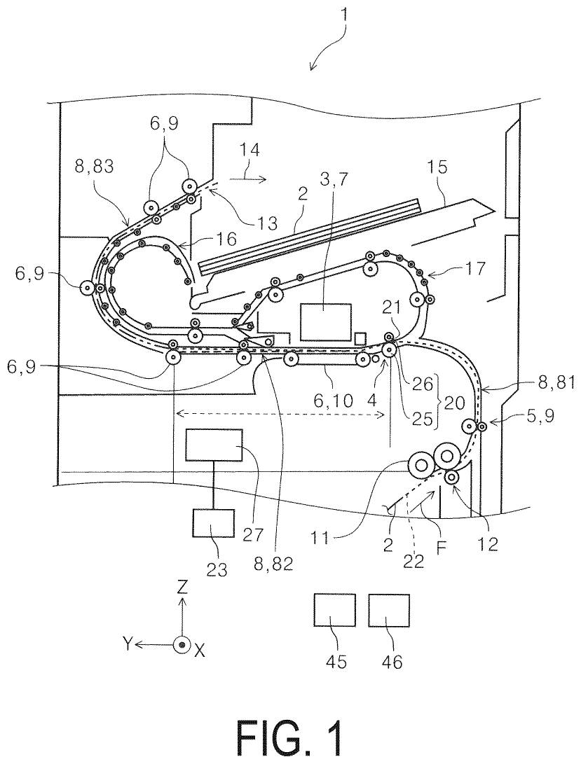

Hereinafter, an skew correction device according to each embodiment of the present disclosure and a control method for the medium processing apparatus, and a medium processing apparatus including the skew correction device will be specifically described based on FIG. 1 to FIG. 7.

In the following description, three axes that are orthogonal to each other are referred to as an X-axis, a Y-axis, and a Z-axis, respectively, as illustrated in each of the drawings. Directions indicated by arrows of the three axes (X, Y, and Z) are + directions of the respective directions, and opposite directions are − directions. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to horizontal directions. A +X direction indicates a frontward direction of the medium processing apparatus, and a −X direction indicates a rearward direction of the apparatus. Here, the X-axis direction is also a width direction of a medium 2 intersecting a transport direction of the medium 2 which will be described later. A +Y direction indicates a leftward direction of the apparatus, and a −Y direction indicates a rightward direction of the apparatus.

### Embodiment 1

### Overall Description of Medium Processing Apparatus

As illustrated in FIG. 1, in Embodiment 1, a medium processing apparatus 1 is an ink jet-type recording device that performs printing by ejecting ink from a recording unit 3 onto the medium 2 such as a sheet being transported.

The medium processing apparatus 1 according to the embodiment includes an skew correction device 4, an upstream transport unit 5 that transports the medium 2 toward the skew correction device 4, that is, in a transport direction F, a downstream transport unit 6 that transports the medium 2 whose skew has been corrected by the skew correction device 4 further downstream, and the recording unit 3 as a processing unit 7 that performs processing on the medium 2 being transported by the downstream transport unit 6.

Here, the recording unit 3 is a line head that performs recording without moving in a width direction (X-axis direction) of the medium 2. The recording unit 3 may be a serial-type recording head that reciprocates in the width direction (X-axis direction) of the medium 2.

The medium processing apparatus 1 includes a first transport path 81, a second transport path 82, and a third transport path 83 as a transport path 8 along which the medium 2 is transported in the transport direction F. The first transport path 81 is a portion of the transport path 8 located upstream of the skew correction device 4. The second transport path 82 and the third transport path 83 are portions of the transport path 8 that are located downstream of the skew correction device 4.

The first transport path 81 is provided with a transport roller pair 9 as the upstream transport unit 5. The second transport path 82 is provided with the transport roller pair 9 and a transporting belt 10 as the downstream transport unit 6. The transporting belt 10 is disposed so as to face the recording unit 3, and transports the medium 2 in the transport direction F while supporting a rear surface of the medium 2 which is on an opposite side to a printed surface. The third transport path 83 is also provided with the transport roller pair 9 as the downstream transport unit 6.

The transport roller pair 9 includes a pair of a driving roller that is driven by power transmitted from a driving source such as a motor, and a driven roller that follows rotation of the driving roller. The transport roller pair 9 drives to impart transport force to the medium 2.

As illustrated in FIG. 1, the first transport path 81 and the third transport path 83 are each a path curved in a substantially U shape. The second transport path 82 is a straight path extending substantially linearly.

A medium accommodation cassette (not illustrated) is disposed at a lower portion of the medium processing apparatus 1. The media 2 accommodated in the medium accommodation cassette are each picked up by a pickup roller (not illustrated) and further receive feeding force from a feeding roller 11, a sheet of the media 2 is separated by a separation roller pair 12, and is fed to the first transport path 81.

The medium 2 transported through the first transport path 81 is subjected to processing for correcting skew by the skew correction device 4. When the medium 2 subjected to skew correction is transported through the second transport path 82 in the transport direction F, ink is ejected from the recording unit 3 to perform printing processing. Furthermore, the medium 2 is transported through the third transport path 83, is discharged from a discharge unit 13 in a discharge direction 14, and is placed above a medium receiving unit 15.

In the embodiment, a switchback path 16 and an inversion path 17 are provided, and a configuration is adopted to be able to perform printing on both sides of the medium 2. Note that the medium 2 transported from the reverse path 17 is transported again to the skew correction device 4. Therefore, a transport roller (not illustrated) provided at the reverse path 17 can be regarded as the upstream transport unit 5.

### Description of Skew Correction Device

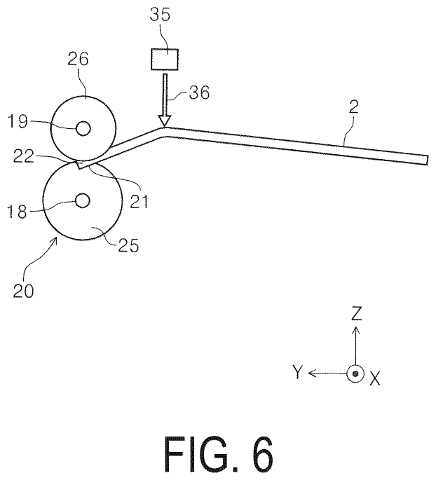

As illustrated in FIGS. 1 to 6, the skew correction device 4 of Embodiment 1 corrects skew by causing a leading end 22 of the medium 2 to butt at a nip position 21 (FIGS. 1 and 6) of a registration roller pair 20 in a stopped state.

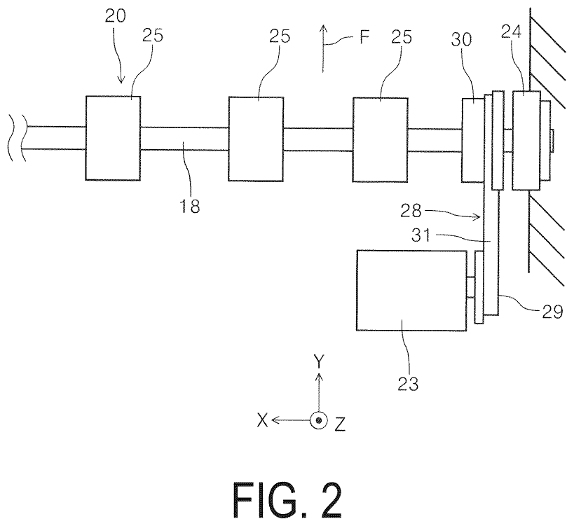

As illustrated in FIGS. 1 and 2, the skew correction device 4 includes the registration roller pair 20, a driving unit 23 such as a motor that drives the registration roller pair 20, and an electromagnetic clutch 24.

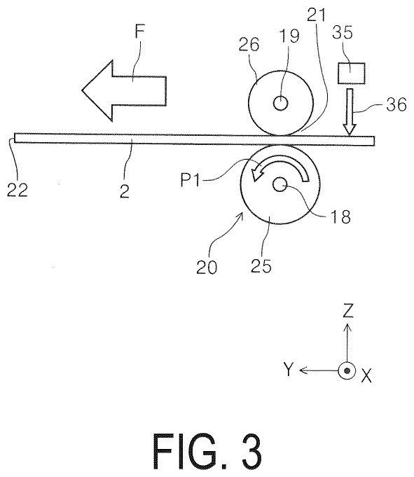

As illustrated in FIG. 3, the registration roller pair 20 includes a pair of a driving roller 25 attached to a rotary shaft 18 and a driven roller 26 attached to the rotary shaft 19.

The driving roller 25 rotates when power from the driving unit 23 is transmitted to the rotary shaft 18 via a power transmission mechanism 28 (FIG. 2). The driven roller 26 follows the rotation of the driving roller 25 to rotate. Note that in FIG. 2, the driven roller 26 is not illustrated.

As illustrated in FIG. 1, the driving unit 23 rotates or stops the driving roller 25 upon receiving a control signal from a control unit 27. The power transmission mechanism 28 includes a pinion 29 on the driving unit 23 side, a pulley 30 on the rotary shaft 18 side, and a transmission belt 31 wound around the pinion 29 and the pulley 30.

Note that instead of the pair of the driving roller 25 and the driven roller 26, the registration roller pair 20 may include a pair of driving rollers to both of which power is transmitted.

As illustrated in FIG. 2, in the embodiment, the electromagnetic clutch 24 is attached to the rotary shaft 18. Then, the electromagnetic clutch 24 is configured to stop rotation of the registration roller pair 20 in an “activated state” and to release the registration roller pair 20 in a “disconnected state”.

The electromagnetic clutch 24 switches between the “activated state” and the “disconnected state” upon receiving a control signal from the control unit 27.

As illustrated in FIG. 3, when electromagnetic clutch 24 is in the “disconnected state”, that is, when the registration roller pair 20 transports the medium 2, the driving unit 23 drives the driving roller 25 of the registration roller pair 20 with a first output P1.

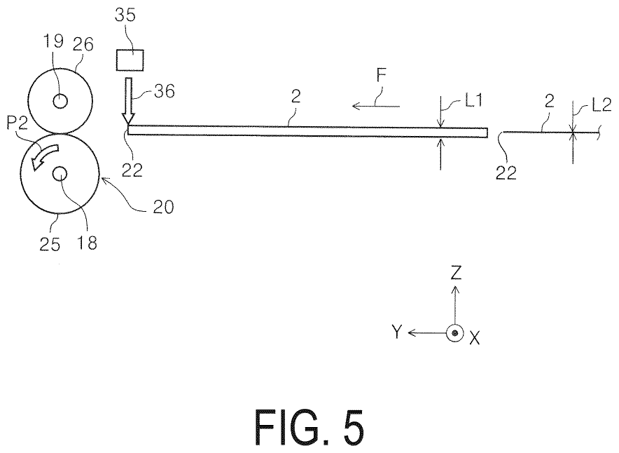

Further, as illustrated in FIG. 5, when the electromagnetic clutch 24 is in the “activated state”, the driving unit 23 performs driving with a second output P2 smaller than the first output P1. In other words, the driving unit 23 drives the driving roller 25 of the registration roller pair 20 with the second output P2 in a state in which the rotation of the registration roller pair 20 is stopped by the electromagnetic clutch 24, thereby making it possible to bring the backlash into the eliminated state. Note that an arrow with a reference numeral P2 illustrated in FIG. 5 denotes a direction of the output, and the driving roller 25 does not necessarily rotate in the direction of the arrow with the reference numeral P2 actually.

In the embodiment, the control unit 27 is configured to rotate the driving roller 25 with the second output P2, and stop the driving unit 23 when the backlash is eliminated. As a result, since the driving unit 23 is in a stopped state in the state in which the backlash is eliminated, an increase in power consumption is suppressed. Note that a configuration may be adopted in which a torque limiter is provided so that the driving unit 23 does not stop but runs idle in the state in which the backlash is eliminated. Alternatively, a configuration may be adopted in which the control unit 27 does not stop the driving unit 23, and the rotation of the driving unit 23 is stopped by a load.

Further, the control unit 27 is configured to switch between the first output P1 and the second output P2.

The above description can be summarized as follows.

That is, the control unit 27 controls the operation of the driving unit 23 and the electromagnetic clutch 24.

To be specific, when the registration roller pair 20 is stopped, the control unit 27 sets the output of the driving unit 23 to the second output P2 (FIG. 5) and brings the electromagnetic clutch 24 into the activated state. Further, when the medium 2 is transported by the registration roller pair 20, the control unit 27 sets the output of the driving unit 23 to the first output P1 (FIG. 3) and brings the electromagnetic clutch 24 into the disconnected state.

Additionally, as illustrated in FIG. 1, in the embodiment, the upstream transport unit 5 is configured to be driven by a second driving unit 45 different from the driving unit 23. Further, the downstream transport unit 6 is also configured to be driven by a third driving unit 46 different from the driving unit 23.

Note that the upstream transport unit 5 and the downstream transport unit 6 may be configured to be driven by only one of the second driving unit 45 and the third driving unit 46.

In addition, in the embodiment, the driving unit 23 is configured to drive only the registration roller pair 20.

### Skew Correction by Skew Correction Device of Embodiment 1

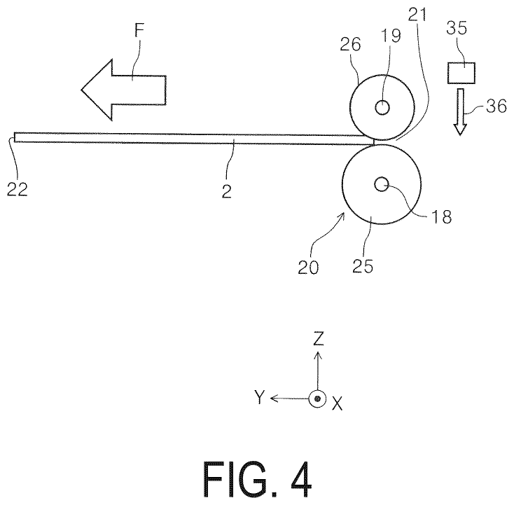

Skew correction by the skew correction device 4 of the embodiment is controlled by the control unit 27 and is performed as follows.
(1) As illustrated in FIG. 3, when the medium 2 is transported toward the recording unit 3 side in the transport direction F, the registration roller pair 20 imparts feeding force corresponding to the first output P1 to the medium 2 by the driving unit 23. At this time, the electromagnetic clutch 24 is in the “disconnected state”.
(2) As illustrated in FIG. 4, when a trailing end of the medium 2 passes through the nip position 21, the driving unit 23 is turned off. As a result, the rotation of the registration roller pair 20 is stopped so that irregular push-out force does not act on the trailing end of the medium 2 when the trailing end of the medium 2 passes through the nip position 21.
(3) As illustrated in FIG. 5, when the leading end 22 of the next medium 2 to be transported through the first transport path 81 is detected by a detection unit 35, the electromagnetic clutch 24 is brought into the “activated state” and the registration roller pair 20 is brought into the stopped state, that is, a locked state. The detection unit 35 is an optical sensor capable of detecting a position of the medium 2 by detecting passage of the medium 2. A reference numeral 36 denotes a light beam for detection.

Further, the driving unit 23 applies rotational force to the registration roller pair 20 with the second output P2 smaller than the first output P1. As a result, the registration roller pair 20 in the locked state rotates by an amount corresponding to the backlash, and the backlash is brought into the eliminated state. In the embodiment, the driving unit 23 is turned off in the state in which the backlash is eliminated.
(4) As illustrated in FIG. 6, in the registration roller pair 20, the leading end 22 of the medium 2 is caused to butt at the nip position 21 in the state in which the backlash is eliminated. Thus, skew correction is performed without being affected by the backlash.

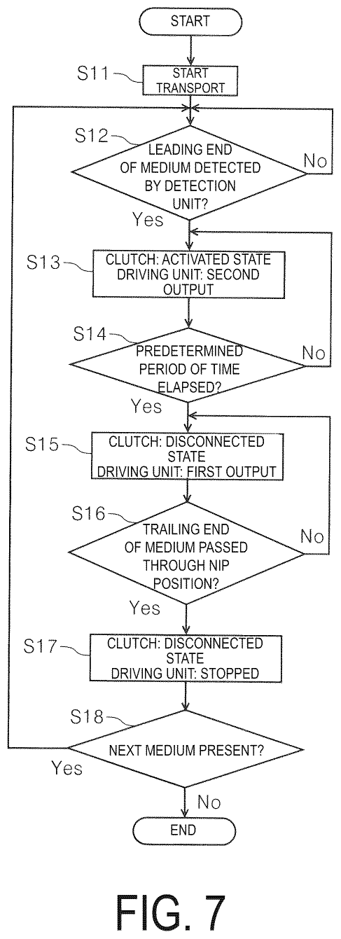

That is, the skew correction by the skew correction device 4 of the embodiment is performed in accordance with a flow illustrated in FIG. 7.

First, as step S11, transport of the medium 2 is started, and in step S12, when the detection unit 35 detects the leading end 22 of the medium 2, the skew correction starts.

In step S12, when the leading end 22 of the medium 2 transported through the first transport path 81 is detected by detection unit 35 (Yes), the control unit 27 brings the electromagnetic clutch 24 into the “activated state” in step S13, brings the registration roller pair 20 into the stopped state, and sets the output of driving unit 23 to the second output P2. On the other hand, when the leading end 22 is not detected in step S12 (No), the transport is continued.

Then, when the leading end 22 of the medium 2 is caused to butt at the registration roller pair 20 in the stopped state (FIG. 6), skew of the medium 2 is corrected. In step S14, a determination is made as to whether a predetermined period of time elapses or not for a sufficient amount of bending to be formed in the medium 2 in which the leading end 22 is caused to butt at the registration roller pair 20. In a case of Yes in step S14, the registration roller pair 20 transports the medium 2 in the transport direction F toward the recording unit 3 side. That is, the control unit 27 brings the electromagnetic clutch 24 into the “disconnected state” and sets the power of the driving unit 23 to the first output P1 to impart feeding force to the medium 2. In a case of No in step S14, the butting of the medium 2 is continued until the predetermined time elapses.

When the medium 2 is transported in the transport direction F by the registration roller pair 20, and a trailing end of medium 2 passes through the nip position 21 (Yes in step S16), the processing proceeds to step S17. In step S17, driving of the registration roller pair 20 is stopped by bringing the electromagnetic clutch 24 into the “disconnected state” and stopping driving of the driving unit 23. When the driving is stopped before the trailing end of the medium 2 passes through the nip position 21, the registration roller pair 20 may follow the transport of the medium 2 to rotate. In a case of No in step S16, the transport of medium 2 is continued until the trailing end of medium 2 reaches the nip position 21. Note that the driving of the driving unit 23 may be stopped after the trailing end of the medium 2 passes through the nip position 21.

Then, the processing proceeds to step S18, and when the next medium 2 is present (Yes), the processing returns to step S12. When there is no next medium 2 in step S18 (No), the processing ends.

### Description of Effects of Embodiment 1

(1) In the embodiment, when the electromagnetic clutch 24 is in the “disconnected state” and the registration roller pair 20 transports the medium 2, the driving unit 23 drives the registration roller pair 20 with the first output P1. Even when the electromagnetic clutch 24 is brought into the “activated state” and the registration roller pair 20 is brought into the stopped state, the driving unit 23 does not stop the driving but drives the registration roller pair 20 with the second output P2.

As a result, even when there is the backlash in the power transmission path from the driving unit 23 to the registration roller pair 20, the backlash can be brought into the eliminated state. Therefore, when the leading end 22 of the medium 2 is caused to butt at the nip position 21 of the registration roller pair 20 for the skew correction, rotation of the registration roller pair 20 by the reaction force of the medium 2 is suppressed. That is, the leading end 22 of the medium 2 is prevented from passing through the nip position 21. This makes it possible to improve accuracy of the skew of medium 2.

In addition, the second power P2 which is the driving force of the driving unit 23 when the backlash is eliminated is set to be smaller than the first power P1 which is the driving force when the medium 2 is transported. Accordingly, an increase in power consumption in the driving unit 23 can be suppressed. In addition, since the second output P2 is smaller than the first output P1, it is possible to suppress an increase in holding force required for the electromagnetic clutch 24, which leads to cost reduction.

In addition, it is possible to suppress an increase in a load of the driving unit 23 such as a motor, as compared to a configuration in which rotation of the registration roller pair 20 due to the reaction force of the medium 2 is suppressed by increasing a sliding load during rotation of the registration roller pair 20. Accordingly, it is possible to suppress an increase in power consumption in the driving unit 23, and additionally, it is possible to reduce a size of the driving unit 23.
(2) In addition, in the embodiment, the control unit 27 performs control so as to, when the registration roller pair 20 is stopped, set the output of the driving unit 23 to the second output P2, and bring the electromagnetic clutch 24 into the “activated state”. When the medium 2 is transported by the registration roller pair 20, the control unit 27 performs control so as to set the output of the driving unit 23 to the first output P1 and bring the electromagnetic clutch 24 into the “disconnected state”. Accordingly, the effects described in (1) above can be easily obtained by performing the control by the control unit 27.
(3) Additionally, in the embodiment, in the medium processing apparatus 1 including the processing unit 7 that performs processing on the medium 2 being transported, it is possible to appropriately perform skew correction of the medium 2, and it is possible to improve accuracy of the processing.
(4) In addition, in the embodiment, the upstream transport unit 5 is driven by the second driving unit 45 different from the driving unit 23. Accordingly, since the driving unit 23 of the registration roller pair 20 is provided separately from the second driving unit 45 of the upstream transport unit 5, it is possible to suppress influence of the control of driving by the driving unit 23 with weak driving force, that is, the second output P2 on the driving force when the medium 2 is caused to butt at the nip position 21 by the second driving unit 45. Consequently, it is possible to suppress an increase in a time of the butting and to suppress a decrease in throughput.
(5) In addition, in the embodiment, the downstream transport unit 6 is driven by the third driving unit 46 different from the driving unit 23. Accordingly, since the driving unit 23 of the registration roller pair 20 is provided separately from the third driving unit 46 of the downstream transport unit 6, it is possible to suppress influence of the control of driving by the driving unit 23 with the weak driving force, that is, the second output P2, on transport force for transporting the preceding medium 2 downstream by the third driving unit 46. Consequently, it is possible to suppress an increase in a processing time of the preceding medium 2 by the processing unit 7 and to suppress a decrease in throughput.
(6) In addition, in the embodiment, the driving unit 23 drives only the registration roller pair 20. Accordingly, since the driving unit 23 becomes a dedicated driving unit for the registration roller pair 20, it is possible to set magnitude of driving force without affecting a driving state of other units. That is, magnitude of the second output P2 can be set to be small without affecting the driving state of the other units.
(7) Additionally, in the embodiment, since it is possible to appropriately perform the skew correction before the medium 2 on which recording is to be performed is transported to a recording performance region by the recording unit 3, it is possible to improve recording accuracy.

### Embodiment 2

Next, the skew correction device 4 according to Embodiment 2, and the medium processing apparatus 1 including the skew correction device 4 will be specifically described based on FIG. 5. The same parts as those in the first embodiment are denoted by the same reference numerals, and description of the configurations and corresponding effects will be omitted.

The skew correction device 4 of Embodiment 2 further includes the detection unit 35 that detects information related to the medium 2. Then, the control unit 27 is configured to determine whether to drive the driving unit 23 or not when the registration roller pair 20 is brought into the stopped state by the electromagnetic clutch 24 based on a detection result of the detection unit 35.

Here, the “information related to the medium 2” is, as an example, information indicating whether the medium 2 easily passes through the nip position 21 or not when the registration roller pair 20 is stopped. The “information related to the medium 2” specifically means physical information related to rigidity such as a thickness, a basis weight, or the like of the medium 2 but may be a parameter related to the physical information. In addition, when the registration roller pair 20 is stopped, a reference value related to the information related to the medium 2 for determining whether to drive the driving unit 23 or not based on a detection result of the detection unit 35 is set in advance.

As the detection unit 35, an optical sensor capable of detecting the thickness of the medium 2 by the light beam 36 for detection is used. Specifically, the detection unit 35 can detect a position of the medium 2 and the thickness of the medium 2 described in Embodiment 1.

Note that the detection unit 35 is not limited to the optical sensor. A constituent member that is included in the medium processing apparatus 1 and is capable of acquiring “information related to the medium 2”, an operation panel to which “information related to the medium 2” is input, a personal computer, or the like may also be used.

In the embodiment, as information related to the medium 2, information including information related to the thickness of the medium 2 is used. Then, the control unit 27 is configured to perform the following control based on the information related to the thickness of the medium 2.

As illustrated in FIG. 5, in a case where the thickness of the medium 2 is a first thickness L1, the control unit 27 drives the driving unit 23 with the second output P2 when the registration roller pair 20 is stopped by the electromagnetic clutch 24. That is, the skew correction of the medium 2 is performed in a state in which the backlash of the registration roller pair 20 is eliminated.

On the other hand, the control unit 27 is configured not to drive the driving unit 23 when the registration roller pair 20 is stopped by the electromagnetic clutch 24 in a case where the thickness of the medium 2 is a second thickness L2 smaller than first thickness L1. That is, the skew correction of the medium 2 is performed while the operation of eliminating the backlash of the registration roller pair 20 is not allowed to be performed.

The medium 2 having the second thickness L2 is a medium having a thickness that allows the skew correction to be performed with high accuracy even when the registration roller pair 20 has the backlash without eliminating the backlash by the sliding resistance. The first thickness L1 and the second thickness L2 are set in advance.

### Skew Correction by Skew Correction Device of Embodiment 2

The skew correction by the skew correction device 4 of the embodiment is controlled by the control unit 27 and is performed as follows.
(1) As illustrated in FIG. 5, in a case where the medium 2 to be subjected to skew correction is the medium 2 having the first thickness L1, when the registration roller pair 20 is stopped, the driving unit 23 is driven with the second output P2. That is, the skew correction of the medium 2 is performed in a state in which the backlash of the registration roller pair 20 is eliminated.
(2) As illustrated in FIG. 5, in a case where the medium 2 to be subjected to the skew correction is the medium 2 having the second thickness L2, when the registration roller pair 20 is stopped, the driving unit 23 is not driven. That is, the skew correction of the medium 2 is performed while the operation of eliminating the backlash of the registration roller pair 20 is not allowed to be performed.

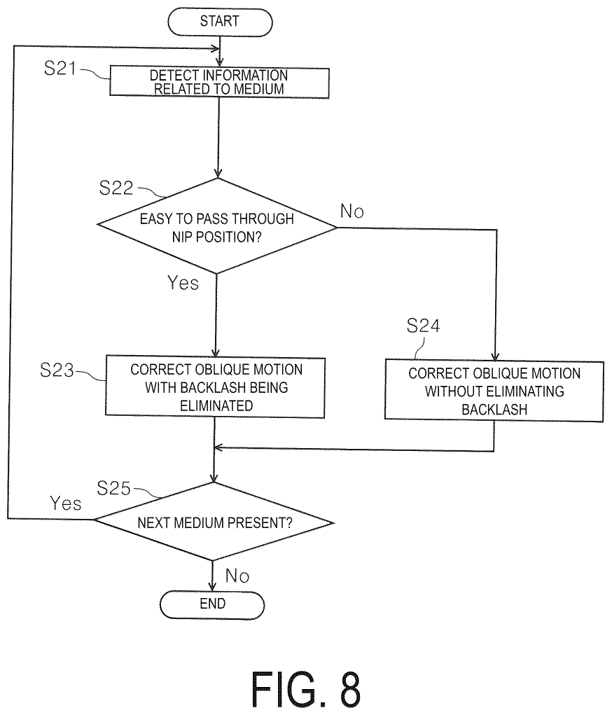

That is, the skew correction by the skew correction device 4 of the embodiment is performed in accordance with a flow illustrated in FIG. 8.

In step S21, the detection unit 35 detects information related to the medium 2. In other words, the control unit 27 acquires the information related to the medium 2. Then, in step S22, the control unit 27 determines whether the medium 2 easily passes through the nip position 22 in a stopped state or not based on the information related to the medium 2 acquired. For example, it is determined whether reaction force of the medium 2 is large or not, and whether the thickness of the medium 2 is large or not. That is, it is determined whether the reaction force of the medium 2 is larger than a threshold value or not and whether the thickness of the medium 2 is larger than a threshold value or not.

In a case of Yes in step S22, the processing proceeds to step S23, and based on the flow of FIG. 7, skew correction of the medium 2 is performed in a state in which the backlash of registration roller pair 20 is eliminated. To be specific, when the registration roller pair 20 is stopped, the driving unit 23 is driven with the second output P2.

On the other hand, in a case of No in step S22, the processing proceeds to step S24 to perform the skew correction of the medium 2 without allowing the operation of eliminating the backlash of the registration roller pair 20 to be performed. Specifically, when the registration roller pair 20 is stopped, the driving unit 23 is not driven.

Then, the processing proceeds to step S25, and when the next medium 2 is present (Yes), the processing returns to step S21. In a case where there is no next medium 2 in step S25 (No), the processing ends.

### Description of Effects of Embodiment 2

(1) When the medium 2 is caused to butt at the nip position 21 of the registration roller pair 20, a case where the rigidity of the medium 2 is low and the reaction force is small may lead to a state in which sliding resistance of the registration roller pair 20 or the like is larger. In this state, the reaction force is less likely to rotate the registration roller pair 20, thus it is possible to perform the skew correction with high accuracy without eliminating the backlash.

In the embodiment, the control unit 27 determines whether to drive the driving unit 23 or not when the registration roller pair 20 is stopped, based on a detection result of the detection unit 35 that detects information related to the medium 2. Accordingly, it is possible to stop the driving unit 23 in a case where the reaction force of the medium 2 is small, and to drive the driving unit 23 in a case where the reaction force of the medium 2 is large, and thus it is possible to avoid unnecessary driving of the driving unit 23 and to suppress power consumption.
(2) As the thickness of the medium 2 increases, the reaction force when the medium 2 is caused to butt at the nip position 21 of the registration roller pair 20 increases, and the leading end 22 of the medium 2 easily passes through the nip position 21. On the other hand, as the thickness of the medium 2 decreases, the reaction force when the medium 2 is caused to butt at the nip position 21 of the registration roller pair 20 decreases, and the leading end 22 of the medium 2 is made unlikely to pass through the nip position 21.

In the embodiment, in a case where the thickness of the medium 2 is the first thickness L1, the control unit 27 performs control so as to drive the driving unit 23 with the second output P2 when the registration roller pair 20 is stopped. On the other hand, in a case where the thickness of the medium 2 is the second thickness L2 smaller than the first thickness L1, the control unit 27 performs control so as not to drive the driving unit 23 when the registration roller pair 20 is stopped. That is, when the thickness of the medium 2 is large, the backlash is eliminated by the driving unit 23, and when the thickness of the medium 2 is small, the backlash is not eliminated. Accordingly, it is possible to suppress unnecessary driving of the driving unit 23, thereby suppressing an increase in power consumption.

### Embodiment 3

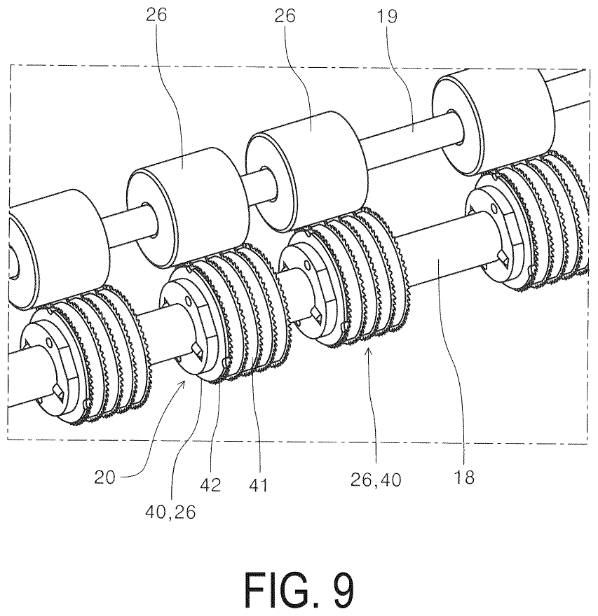

Next, the skew correction device 4 according to Embodiment 3, and the medium processing apparatus 1 including the skew correction device 4 will be specifically described based on FIG. 9. The same parts as those in the first embodiment or the second embodiment are denoted by the same reference numerals, and the description of the configurations and corresponding effects will be omitted.

In the embodiment, the registration roller pair 20 includes a toothed roller 40 as illustrated in FIG. 9. Here, the driving roller 26 includes the toothed roller 40. The toothed roller 40 is a roller having a plurality of teeth, that is, protrusions 42, at an outer surface 41 thereof, and portions of the protrusions 42 come into contact with the medium 2 so that contact areas with the medium 2 can be brought into a point contact state.

When the registration roller pair 20 includes the toothed roller 40, there is a problem in that the registration roller pair 20 is structurally more likely to rotate when the registration roller pair 20 is subjected to butting of the medium 2 as compared with a registration roller without the protrusions 42.

In the embodiment, since the backlash is in an eliminated state, the registration roller pair 20 is possible to effectively perform skew correction without being affected by a problem caused by movement of the registration roller pair 20 due to the backlash.

In particular, in a configuration in which skew of the medium 2 is corrected again by the registration roller pair 20 for double-sided printing, transfer can be suppressed by using the toothed roller 40.

### Other Embodiments

The skew correction device 4 and the control method thereof according to the present disclosure, and the medium processing apparatus 1 including the skew correction device 4 basically have the configuration of the above-described embodiment, but it is of course possible to change or omit any part of the configuration without departing from the gist of the present disclosure. In the above-described embodiment, the medium processing apparatus 1 is described as the recording device including the recording unit 3, specifically, the ink jet printer, however, the medium processing apparatus 1 is also applicable to other recording devices. Furthermore, the present disclosure can be applied to a reading apparatus such as a scanner or an ADF, a finisher, and a recording system including a relay unit. In this case, the processing unit 7 may be a reading unit that reads an image, a post-processing unit that performs post-processing on a medium, a drying unit that dries a transported medium, or the like.

What is claimed is:

1. An skew correction device that corrects skew by placing a leading end of a medium at a nip position of a registration roller pair, the skew correction device comprising:
the registration roller pair;
a driving unit configured to drive the registration roller pair; and
an electromagnetic clutch configured to stop the registration roller pair in an activated state and release the registration roller pair in a disconnected state, wherein the driving unit
drives the registration roller pair with a first output when the registration roller pair transports the medium, and performs driving with a second output smaller than the first output in the activated state.

2. The skew correction device according to claim 1, further comprising a control unit configured to control the driving unit and the electromagnetic clutch, wherein
the control unit
sets an output of the driving unit to the second output when the registration roller pair is stopped by bringing the electromagnetic clutch into the activated state, and
sets the output of the driving unit to the first output and brings the electromagnetic clutch into the disconnected state when the medium is transported by the registration roller pair.

3. The skew correction device according to claim 2, further comprising a detection unit configured to detect information related to the medium, wherein
the control unit determines whether to drive the driving unit or not when the registration roller pair is stopped by bringing the electromagnetic clutch into the activated state based on a detection result of the detection unit.

4. The skew correction device according to claim 3, wherein the information related to the medium includes information related to a thickness of the medium, and
the control unit, when the thickness of the medium is a first thickness, drives the driving unit with the second output when the registration roller pair is stopped by bringing the electromagnetic clutch into the activated state, and
the control unit, when the thickness of the medium is a second thickness smaller than the first thickness, does not drive the driving unit when the registration roller pair is stopped by bringing the electromagnetic clutch into the activated state.

5. The skew correction device according to claim 1, wherein the registration roller pair includes a toothed roller.

6. A medium processing apparatus, comprising:
the skew correction device according to claim 1;
an upstream transport unit configured to transport the medium to the skew correction device;
a downstream transport unit configured to transport the medium whose skew has been corrected by the skew correction device; and
a processing unit configured to perform processing on the medium transported through the downstream transport unit.

7. The medium processing apparatus according to claim 6, wherein
the upstream transport unit is driven by a second driving unit different from the driving unit.

8. The medium processing apparatus according to claim 6, wherein
the downstream transport unit is driven by a third driving unit different from the driving unit.

9. The medium processing apparatus according to claim 6, wherein
the driving unit drives only the registration roller pair.

10. The medium processing apparatus according to claim 6, wherein
the processing unit is a recording unit that performs recording on the medium, and
the recording unit performs recording on the medium whose skew has been corrected by the skew correction device.

11. A control method for an skew correction device that corrects skew by placing a leading end of a medium at a nip position of a registration roller pair, the control method comprising:
when the medium is transported by the registration roller pair,
setting an output of a driving unit that drives the registration roller pair to a first output, and
releasing the registration roller pair by bringing an electromagnetic clutch, that stops the registration roller pair in an activated state and releases the registration roller pair in a disconnected state, into the disconnected state; and
when the registration roller pair is stopped,
setting the output of the driving unit to a second output smaller than the first output and
stopping the registration roller pair, by bringing the electromagnetic clutch into the activated state.

12. The control method for the skew correction device according to claim 11, comprising:
acquiring information related to the medium; and
determining whether to drive the driving unit or not when the registration roller pair is stopped based on the information related to the medium acquired.
